(19) United States
(12) Patent Application Publication
(10) Pub. No.: US 2006/0279622 A1
(43) Pub. Date: Dec. 14, 2006

(54) Sheet-feeding module for double-side printing and double-side printing method

(76) Inventor: Tsung-Fu Kao, Shenkeng Township (TW)

Correspondence Address: J.C. Patents, Inc., 4 Venture, Suite 250, Irvine, CA, 92618, US

(21) Appl. No.: 11/450,061

(22) Filed: Jun. 9, 2006

(30) Foreign Application Priority Data
Jun. 10, 2005 (TW) 94119185

(51) Int. Cl. B41J 2/01

(52) U.S. Cl. 347/104

(57) ABSTRACT

A sheet-feeding module for double-side printing suitable to be built in a printing device is disclosed. The sheet-feeding module includes a sheet-feeding mechanism, a sheet-transferring path, a sheet-printing path a first sensor, a first sheet-conveying mechanism, a sheet-discharging path and a sheet-returning path. The first sheet-conveying mechanism is suitable for conveying back the sheet with one side printed which is on the sheet-discharging path, via the sheet-returning path, onto the sheet-feeding mechanism, and then the sheet with one side printed is conveyed onto the sheet-printing path again by the sheet-feeding mechanism for performing the printing of the other side of the sheet. Therefore, the printing device with the built-in sheet-feeding module for double-side printing, without an additional plug-in double-side printing module of prior art, not only the cost required in a printing device with double-side printing function can be reduced but also the double-side printing efficiency enhanced.

### CROSS-REFERENCE TO RELATED APPLICATION

This application claims the priority benefit of Taiwan application serial no. 94119185, filed on Jun. 10, 2005. All disclosure of the Taiwan application is incorporated herein by reference.

### BACKGROUND OF THE INVENTION

1. Field of Invention

The present invention relates to a sheet-feeding module, and particularly to a sheet-feeding module suitable to be built in a printing device for double-side printing.

2. Description of the Related Art

Along with the progress in electronic technology, various business equipments in the office, such as copy machine, fax-machine, printer, are indispensable information facilities. Normally, a printer can only provide single-side printing function.

To reduce the printing cost and paper consumption, the double-side printing method is used. To achieve the double-side printing function, the manual method is to overturn the sheet with one-side printed already and place it in the paper tray again for the printing of the other side of the sheet. Alternatively, the high-end printer is usually equipped with a plug-in double-side printing module to achieve the double-side printing function.

FIG. 1 is a schematic diagram of a printer with a plug-in double-side printing module in the prior art. Referring to FIG. 1, a printer 100 includes a paper tray 110, a sheet-feeding mechanism 120, a sensor 130, a print head 140, a sheet-conveying mechanism 150, a sheet-discharging port 160, a double-side printing module 170, a sheet-feeding path P11, a sheet-transferring path P12, a sheet-printing path P13, a sheet-discharging path P14 and a sheet-flipping path p15. The sensor 130 is disposed on the sheet-printing path P13 for detecting paper sheets from the sheet-feeding mechanism 120 going towards the print head 140. The sheet-feeding mechanism 120 is connected between the paper tray 110 and the sheet-printing path P13 for picking up the sheets placed in the paper tray 110 and transferring the sheets onto the sheet-feeding path P11 and then the sheet-transferring path P12. The above-mentioned sheet-feeding path P11 is a path around the partial contour of the sheet-feeding mechanism 120 and connected to one end of the sheet-transferring path P12. The sheet-transferring path P12 is connected between the sheet-feeding path P11 and the sheet-printing path P13, provided as a path for transferring the sheets. The sheet-printing path P13 is connected to one end of the sheet-discharging path P14. The print head 140 is located on the sheet-printing path P13 for the printing of the paper sheets passing through the sheet-printing path P13. The sheet-conveying mechanism 150 is located on the sheet-discharging path P14 for pushing the paper sheets thereon forward. The sheet-discharging port 160 is disposed at one end of the sheet-discharging path P14 for discharging the printed sheets. The structure is described in more detail as follows. The aforementioned sheet-feeding mechanism 120 includes a sheet-feeding roller 124, a plurality of press rollers 122, a sheet-guider 126 and a sheet-transferring roller 128. Wherein, both the press rollers 122 and the sheet-feeding roller 124 are disposed on the sheet-feeding path P11, while the sheet-guider 126 and the sheet-transferring roller 128 are disposed on the sheet-transferring path P12 and at one end of the sheet-transferring path P12, respectively. These press rollers 122 work with the sheet-feeding roller 124 for picking up the paper sheets and smoothly sending them onto the sheet-feeding path P11 and the sheet-transferring path P12. The sheet-guider 126 is located on the sheet-transferring path P12 for guiding the paper from the sheet-feeding path P11 onto the sheet-printing path P13; while the sheet-transferring roller 128 is used for driving and delivering the paper downward onto the sheet-printing path P13 or upward apart from the sheet-printing path P13.

To achieve the double-side printing function, the printer 100 must be equipped with an additional plug-in double-side printing module 170 disposed at one side of the sheet-feeding mechanism 120. The double-side printing process of the printer 100 shown in FIG. 1 is explained hereafter.

Firstly, the sheet-feeding mechanism 120 picks up a sheet placed in the paper tray 110 and brings it onto the sheet-feeding path P11, and the sheet-transferring roller 128 leads the sheet from the sheet-transferring path P12 to the sheet-printing path P13. Next, the print head 140 prints the sheet on the sheet-printing path P13, and thus one side of the sheet is printed. At this time, an end of the sheet stays on the sheet-transferring roller 128. Next, the sheet-transferring roller 128 turns in reverse to send the sheet backwards. The sheet is reversely transferred again to the sheet-transferring path P12 and going towards the sheet-overturning path P15 in the double-side printing module 170. Thus, the sheet with the other side to be printed enters the sheet-overturning path P15 and overturns herein. The above-mentioned double-side printing module 170 includes two sheet-conveying rollers 172, a plurality of press rollers 174, a sheet-overturning path P15 and a double-side sheet-feeding switch 176. The double-side printing module 170 receives sheets from the sheet-transferring path P12 and the double-side sheet-feeding switch 176 leads the sheets into the double-side printing module 170. Then, the sheet is transferred along the sheet-overturning path P15 and overturned herein, then transferred again to the sheet-printing path P13 by the sheet-transferring roller 128. At this time, the blank side of the sheet faces the print head 140. In the end, the other side of the sheet is printed by the print head 140. The sheet with double-side printed already is transferred by the sheet-conveying mechanism 150 onto the sheet-discharging path P14. At last, when the sheet reaches the sheet-discharging port 160, it is outputted and placed in a paper tray (not shown) of the printer 100. Thus, the double-side printing process for a sheet is completed.

From the above, it can be seen that in a conventional printer, an additional double-side printing module must be added for offering the double-side printing function. However, the additional cost for this double-side printing module is very high and not cost-efficient. On the other hand, with the double-side printing module, a sheet ought to be conveyed through the sheet-printing path P13 back and forth for three times, which leads to lower printing efficiency.

### SUMMARY OF THE INVENTION

Accordingly, an object of the present invention is to provide a sheet-feeding module used for double-side printing. The sheet-feeding module of the present invention is suitable to be built in a printing device to reduce the cost required in a conventional printing device with double-site printing function and to effectively enhance the double-side printing efficiency.

Another object of the present invention is to provide a double-side printing method for effectively enhancing the double-side printing efficiency.

To achieve the aforementioned goals or the others, the present invention provides a sheet-feeding module for double-side printing suitable to be built in a printing device, and the printing device comprises at least a paper tray, a print head and a sheet-discharging port. The sheet-feeding module for double-side printing includes a sheet-printing path, a sheet-feeding mechanism, a sheet-transferring path, a sheet-discharging path, a first sensor, a first sheet-conveying mechanism and a sheet-returning path. The sheet-discharging path and the sheet-printing path are connected to each other, and the sheet-discharging port is located at an end of the sheet-discharging path. The print head is disposed on the sheet-printing path. The first sensor is disposed on the sheet-discharging path for detecting the passing of sheets. Both the sheet-feeding mechanism and the sheet-transferring path are connected between the paper tray and the sheet-printing path for picking up the sheets placed in the paper tray. The first sheet-conveying mechanism is located on the sheet-discharging path and between the first sensor and the sheet-discharging port for conveying the sheets. The sheet-returning path is connected between the first sheet-conveying mechanism and the sheet-feeding mechanism. The above-mentioned first sheet-conveying mechanism is used for conveying back the sheet with one side printed which is on the sheet-discharging path, via the sheet-returning path, onto the sheet-feeding mechanism. Then, the sheet-feeding mechanism conveys the sheet with one side printed onto the sheet-printing path for performing the printing of the other side of the sheet.

According to an embodiment of the present invention, the above-described first sheet-conveying mechanism includes a driving roller and a driven roller.

According to an embodiment of the present invention, the above-described sheet-feeding module for double-side printing can further include a second sheet-conveying mechanism disposed on the sheet-printing path such that the sheets can be printed evenly.

According to an embodiment of the present invention, the above-described second sheet-conveying mechanism includes a driving roller and a driven roller.

According to an embodiment of the present invention, the above-described sheet-feeding module for double-side printing can further include a third sheet-conveying mechanism disposed on the sheet-returning path for conveying sheets into the sheet-feeding mechanism.

According to an embodiment of the present invention, the above-described third sheet-conveying mechanism includes a driving roller and a driven roller.

According to an embodiment of the present invention, the above-described third sheet-conveying mechanism and second sheet-conveying mechanism use the same driving roller.

According to an embodiment of the present invention, the above-described sheet-feeding mechanism includes a sheet-feeding roller and a plurality of press rollers, and the two kinds of rollers work together for conveying sheets onto the sheet-printing path.

According to an embodiment of the present invention, the above-described sheet-feeding mechanism can further include a sheet-guider disposed between the sheet-feeding mechanism and the sheet-printing path for guiding the sheets from the sheet-feeding mechanism onto the sheet-printing path.

According to an embodiment of the present invention, the above-described sheet-feeding mechanism can further include a sheet-transferring roller disposed on the sheet-guider for transferring the sheets one by one.

According to an embodiment of the present invention, the above-described sheet-feeding module for double-side printing can further include a second sensor disposed on the sheet-printing path for detecting the sheets coming from the sheet-feeding mechanism and going towards the print head.

Based on the above-described objects or the other objects, the present invention provides a double-side printing method, including the following steps: picking up a sheet from a paper tray by a sheet-feeding mechanism and sending it onto a sheet-transferring path; transferring the sheet onto a sheet-printing path for printing one side of the sheet; conveying the sheet with one side printed onto a sheet-discharging path; conveying back the sheet with one side printed which is on the sheet-discharging path, via a sheet-returning path but not via the sheet-printing path, onto the sheet-feeding mechanism; and conveying the sheet with one side printed onto the sheet-printing path by the sheet-feeding mechanism for printing the other side of the sheet.

The sheet-feeding module for double-side printing of the present invention can be built inside a printing device. The sheet-feeding module for double-side printing of the present invention not only can reduce the cost required in a conventional printing device, but also effectively enhance the double-side printing efficiency.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic diagram of a printer with a plug-in double-side printing module.

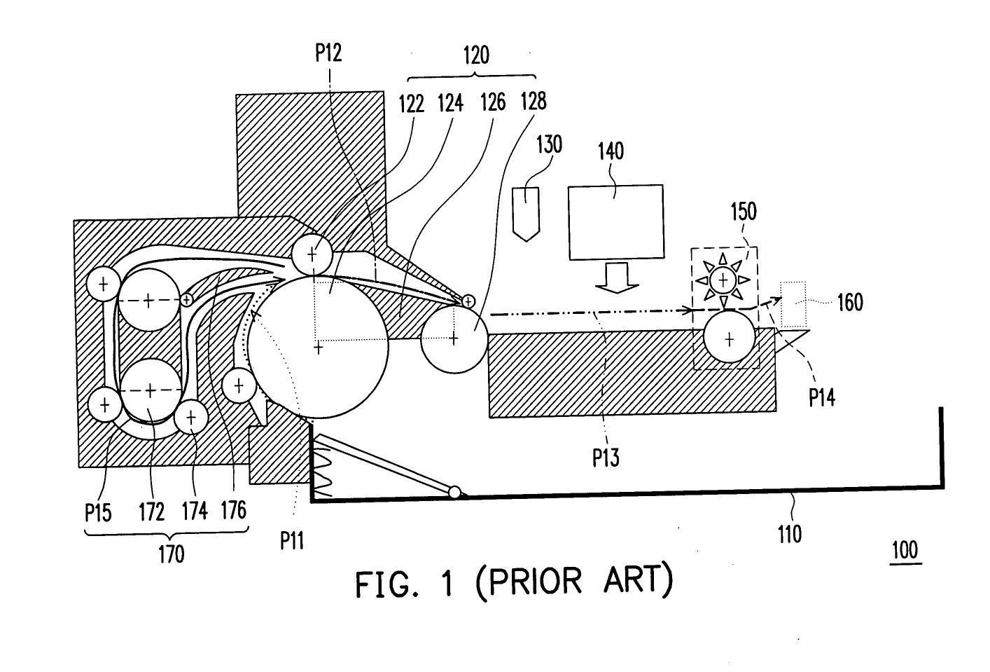

FIG. 2 is a schematic diagram of a sheet-feeding module for double-side printing according to an embodiment of the present invention.

FIG. 3 is a schematic flowchart of the double-side printing method according to an embodiment of the present invention.

### DESCRIPTION OF THE EMBODIMENTS

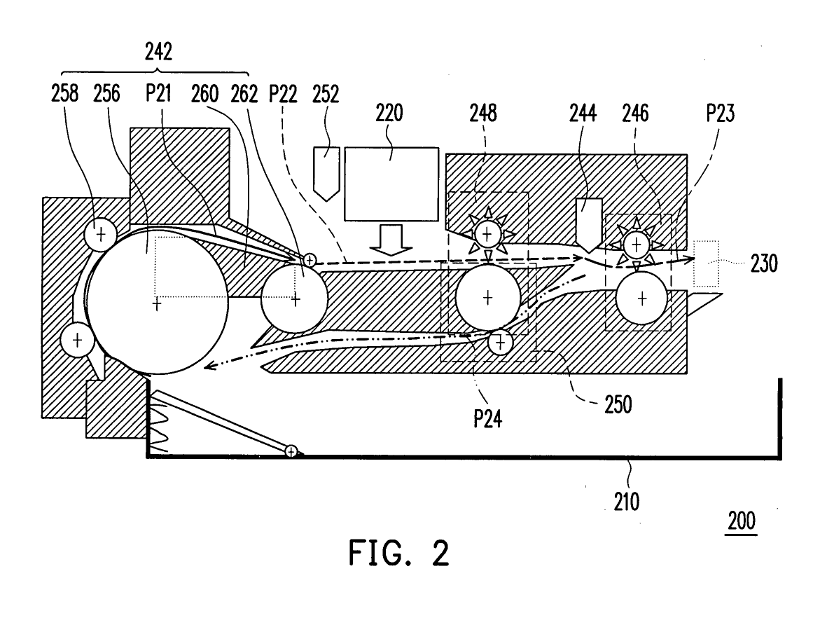

FIG. 2 is a schematic diagram of a sheet-feeding module for double-side printing applied in a printing device according to an embodiment of the present invention. The sheet-feeding module for double-side printing of the present invention is suitable to be built in a printing device, such as a printer. Referring to FIG. 2, the printer 200 includes a paper tray 210, a print head 220, a sheet-discharging port 230 and a sheet-feeding module for double-side printing of the present invention. The sheet-feeding module for double-side printing includes a sheet-feeding mechanism 242, a first sensor 244, a first sheet-conveying mechanism 246, a sheet-transferring path P21, a sheet-printing path P22, a sheet-discharging path P23 and a sheet-returning path P24. In the printer 200, the paper tray 210 and the sheet-feeding mechanism 242 are connected to each other. The print head 220 is disposed on the sheet-printing path P22. The sheet-discharging port 230 is located at an end of the sheet-discharging path P23. In the sheet-feeding module for double-side printing, both the sheet-feeding mechanism 242 and the sheet-transferring path P21 are connected between the paper tray 210 and the sheet-printing path P22, and the sheet-returning path P24 is connected between the first sheet-conveying mechanism 246 and the sheet-feeding mechanism 242. In addition, the first sensor 244 is disposed on the sheet-discharging path P23 for detecting the passing sheets. The first sheet-conveying mechanism 246 is located on the sheet-discharging path P23 and between the first sensor 244 and the sheet-discharging port 230. The paper sheet transferring process in the printer 200 is described in detail below.

First, the sheet-feeding mechanism 242 picks up a sheet placed in the paper tray 210 and puts it on the sheet-transferring path P21, and then the sheet is transferred onto the sheet-printing path P22 for printing one side of the sheet. In other words, the sheet to be printed is picked up from the paper tray 210, transferred by the sheet-feeding mechanism 242, via the sheet-transferring path P21, entering the sheet-printing path P22, and printed with the print head 220. In an embodiment, the sheet-feeding module for double-side printing can further include a second sheet-conveying mechanism 248 disposed on the sheet-printing path P22, so that the sheet is able to be printed evenly by the print head 220. The above-mentioned second sheet-conveying mechanism 248 can be the combination of a driving roller accompanied by a driven roller.

In addition, the above-described sheet-feeding mechanism 242 can include a sheet-feeding roller 256 and a plurality of press rollers 258. The sheet-feeding roller 256 and these press rollers 258 are used to bring the sheet onto the sheet-transferring path P21. Besides, the sheet-feeding mechanism 242 can further include a sheet-guider 260 and a sheet-transferring roller 262. The sheet-guider 260 is connected between the paper tray 210 and the sheet-printing path P22 for guiding the sheet on the sheet-transferring path P21. The sheet-transferring roller 262 is disposed on the sheet-guider 260 for transferring sheets onto the sheet-printing path P22 one by one.

Next, the print head 220 prints one side of the sheet on the sheet-printing path P22. After that, the sheet passes through the first sensor 244. The first sensor 244 can senses the passing of the end of a sheet and send a signal indicating the sheet passing through the first sensor 244, which suggests one side of the sheet is printed. Then, the sheet with one side printed is conveyed by the first sheet-conveying mechanism 246 and arrives at the sheet-discharging port 230. In an embodiment, the first sheet-conveying mechanism 246 can comprise a driving roller and a driven roller accompanied.

Finally, the other side of the sheet is to be printed. The above-described sheet with one side printed is still held by the first sheet-conveying mechanism 246. At this point, the first sheet-conveying mechanism 246 conveys the sheet in a reverse direction, so that the sheet goes back onto a sheet-returning path P24 and returns to the sheet-feeding mechanism 242. Note that the sheet-returning path P24 is different from the sheet-printing path P22. Since the sheet-returning path P24 is connected between the first sheet-conveying mechanism 246 and the sheet-feeding mechanism 242, the sheet is brought onto the sheet-transferring path P21 again. Also, the sheet-feeding mechanism 242 conveys the sheet onto the sheet-printing path P22 for printing the other side of the sheet with the print head 220. In the end, the sheet with the other side printed is conveyed by the first sheet-conveying mechanism 246 and arrives at the sheet-discharging port 230. In an embodiment, the sheet-feeding module for double-side printing can further include a third sheet-conveying mechanism 250, which is disposed on the sheet-returning path P24 to assist the returning of the sheet onto the sheet-transferring path P21. The third sheet-conveying mechanism 250 comprises a driving roller accompanied by a driven roller. The driving roller of the second sheet-conveying mechanism 248 drives the driven roller of the third sheet-conveying mechanism 250 as well; that is, the third sheet-conveying mechanism 250 and the second sheet-conveying mechanism 248 share a driving roller (as shown in FIG. 2). In an embodiment, the printer 200 includes a second sensor 252 disposed on the sheet-printing path P22 for detecting the sheet coming from the sheet-transferring path P21 and going towards the print head 220.

Besides, at the intersection of the sheet-printing path P22, the sheet-discharging path P23 and the sheet-returning path P24, a height difference configuration can be designed, so that the sheet on the sheet-discharging path P23 is prevented from wrongfully entering the sheet-printing path P22 as the sheet is conveyed in the reverse direction to enter the sheet-returning path P24.

Briefly, the sheet-feeding module for double-side printing of the present invention works essentially by conveying a sheet with one side printed back by the first sheet-conveying mechanism 246, via the sheet-returning path P24, to the sheet-feeding mechanism 242, then again conveying the sheet with one side printed by the sheet-feeding mechanism 242 onto the sheet-printing path P22 for printing the other side of the sheet. In comparison with the conventional art, where a plug-in double-side printing module is applied with additional cost, the sheet-feeding module provided by the present invention can be built in a printing device without adding other hardware and the cost for double-side printing function is dramatically reduced. In addition, the sheet-feeding module suitable to be built in a printing device occupies a smaller space than the conventional double-side printing module.

Therefore, from the above described, the sheet-feeding module for double-side printing of the present invention can not only reduce the cost required in a conventional printing device for double-side printing function, but also effectively raise the double-side printing efficiency.

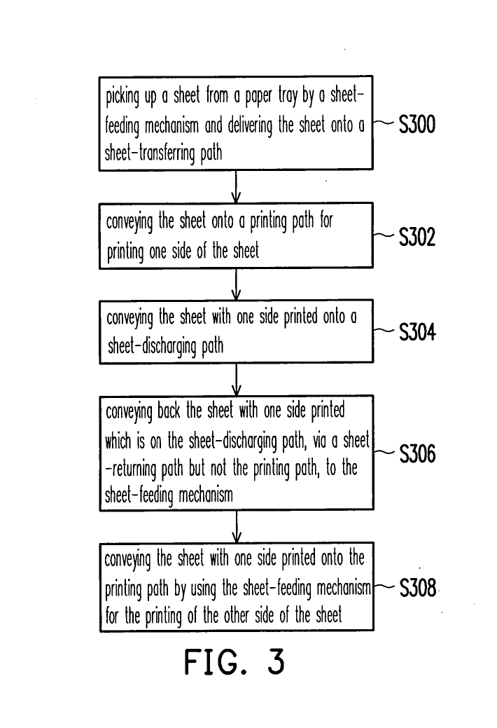

FIG. 3 is a schematic flowchart of a double-side printing method. Referring to FIG. 3, at step S300, a paper sheet is picked up from a paper tray by a sheet-feeding mechanism and is delivered onto a sheet-transferring path. Next, at step S302, the sheet is conveyed onto a sheet-printing path for performing the printing of one side of the sheet. Then at step S304, the sheet with one side printed is conveyed onto a sheet-discharging path. And then, at step S306 as shown in FIG. 3, the sheet with one side printed which is on the sheet-discharging path is conveyed back, via a sheet-returning path but not via the sheet-printing path, onto the sheet-feeding mechanism. Finally at step S308, the sheet with one side printed is conveyed onto the sheet-printing path by sheet-feeding mechanism for performing the printing of the other side of the sheet.

In summary, the sheet-feeding module provided by the present invention can be built in a printing device without using a plug-in double-side printing module in the prior art, therefore not only the cost required in a conventional printing device with double-site printing function can be reduced, but also the double-side printing efficiency can be effectively raised.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A sheet-feeding module for double-side printing, suitable to be built in a printing device which has at least a paper tray, a print head and a sheet-discharging port; the sheet-feeding module comprising:
a sheet-printing path, whereon the print head is located;
a sheet-feeding mechanism, connected between the paper tray and the sheet-printing path for picking up a sheet placed in the paper tray;
a sheet-transferring path, connected between the paper tray and the sheet-printing path;
a sheet-discharging path, connected to the sheet-printing path, wherein the sheet-discharging port is located at one end of the sheet-discharging path;
a first sensor, disposed on the sheet-discharging path for detecting the passage of the sheet;
a first sheet-conveying mechanism, disposed on the sheet-discharging path and located between the first sensor and the sheet-discharging port for conveying the sheet; and
a sheet-returning path, connected between the first sheet-conveying mechanism and the sheet-feeding mechanism,
wherein, the first sheet-conveying mechanism is suitable for conveying back the sheet with one side printed which is on the sheet-discharging path, via the sheet-returning path, onto the sheet-transferring path, and then the sheet with one side printed is conveyed onto the sheet-printing path again by the sheet-feeding mechanism for performing the printing of the other side of the sheet.

2. The sheet-feeding module for double-side printing as recited in claim 1, wherein the first sheet-conveying mechanism comprises a driving roller and a driven roller.

3. The sheet-feeding module for double-side printing as recited in claim 1, further comprising a second sheet-conveying mechanism disposed on the sheet-printing path such that the sheet is printed evenly.

4. The sheet-feeding module for double-side printing as recited in claim 3 wherein the second sheet-conveying mechanism comprises a driving roller and a driven roller.

5. The sheet-feeding module for double-side printing as recited in claim 1, further comprising a third sheet-conveying mechanism, disposed on the sheet-returning path for conveying the sheet to the sheet-feeding mechanism.

6. The sheet-feeding module for double-side printing as recited in claim 5, wherein the third sheet-conveying mechanism comprises a driving roller and a driven roller.

7. The sheet-feeding module for double-side printing as recited in claim 6, wherein the third sheet-conveying mechanism and the second sheet-conveying mechanism use a same driving roller.

8. The sheet-feeding module for double-side printing as recited in claim 1, wherein the sheet-feeding mechanism comprises a sheet-feeding roller and a plurality of press rollers and the sheet-feeding roller works with the press rollers for conveying the sheet from the paper tray onto the sheet-printing path.

9. The sheet-feeding module for double-side printing as recited in claim 8, wherein the sheet-feeding mechanism further comprises a sheet-guider disposed between the sheet-feeding mechanism and the sheet-printing path for guiding the sheet from the sheet-feeding mechanism onto the sheet-printing path.

10. The sheet-feeding module for double-side printing as recited in claim 9, wherein the sheet-feeding mechanism further comprises a sheet-transferring roller disposed on the sheet-guider for conveying sheets one by one.

11. The sheet-feeding module for double-side printing as recited in claim 1, further comprising a second sensor disposed on the sheet-printing path for detecting the sheet coming from the sheet-feeding mechanism and going towards the print head.

12. A double-side printing method, comprising:
picking up a sheet from a paper tray by a sheet-feeding mechanism and delivering the sheet onto a sheet-transferring path;
conveying the sheet onto a sheet-printing path for printing one side of the sheet;
conveying the sheet with one side printed onto a sheet-discharging path;
conveying back the sheet with one side printed which is on the sheet-discharging path, via a sheet-returning path but not via the sheet-printing path, to the sheet-feeding mechanism; and
conveying the sheet with one side printed onto the sheet-printing path by the sheet-feeding mechanism for printing the other side of the sheet.
